(19) United States
(12) Patent Application Publication
(10) Pub. No.: US 2002/0028686 A1
(43) Pub. Date: Mar. 7, 2002

(54) Short message service ordering system

(76) Inventor: Michael Kagi, Erlenbach (CH)

Correspondence Address: ROBERT E. BUSHNELL, 1522 K STREET NW, SUITE 300, WASHINGTON, DC, 200051202

(21) Appl. No.: 09/852,153

(22) Filed: May 10, 2001

(30) Foreign Application Priority Data
Sep. 5, 2000 (CH) 1733/00
Sep. 13, 2000 (CH) PCT/CH00/00495

(51) Int. Cl. H04Q 7/20

(52) U.S. Cl. 455/466; 455/424; 455/437

(57) ABSTRACT

The invention concerns a method, a system and a device for a short message service ordering system for mobile terminals, such as mobile telephones. Through a short message service center (Short message service center) short messages with an enquiry are transmitted to users. For every user, a monitoring function (user session management) is initialized. At least one further message between the user and the short message service center is exchanged. During the exchanging of further messages continuously a status check and a status updating for the user are effected at or through the short message service center.

### CLAIM OF PRIORITY

This application makes reference to, incorporates the same herein, and claims all benefits accruing under 35 U.S.C. §119 from my application SHORT MESSAGE SERVICE ORDERING SYSTEM filed with the Swiss Federal Intellectual Property Office on Sep. 5, 2000 and there duly assigned Ser. No. CH 1733/00.

### BACKGROUND OF THE INVENTION

1. Field of the Invention

This invention pertains to virtual short message service in Global System for mobile Communication mobile telephones. More particularly, this invention pertains to a method and an apparatus for making offers for sale, and accepting the offers of the sale of goods using the short message service of a mobile telephone.

2. Description of the Related Art

Short message services are utilized in wireless communications networks, in particular in mobile telephone networks, such as, for example, networks in accordance with the global system for mobile communication standard (GSM). The specialist is familiar with the design and operating method of a mobile telephone network as well as of short message services, among others in accordance with the ETSI (European Telecommunications Standards Institute, www.etsi.org), ISO standards (www.iso.ch), respectively, the European Telecommunications Standard Institute global system for mobile communication-short message service Standard 3.40, so that in the following only particularities conditional on the invention will be made reference to.

Short message services, so-called (SMS), make possible the despatching and receiving of short messages with up to 160 characters with a mobile telephone or corresponding terminals. Longer messages can also be transmitted, whereby the specifications permit the linking of up to 255 short messages to a longer message.

From the European patent application EP 0 986 273 it is known, i.a., how to transmit advertising to a mobile telephone via short message. In practice it becomes manifest, that dispersion advertising to a multitude of people only makes possible allows marketing methods with a limited success. Marketing campaigns of this type represent a one-sided communication, which cannot lead to immediate purchasing actions of the people addressed, but only serve to communicate the advertising message. The actual purchasing action has to be transacted separately, for example, by telephone or by the manual processing of short messages.

Short message service services are known, in which users send a short message (SM) to a certain telephone number and thereupon receive, e.g., timetable information. A short message of this type is processed by a short message service center (SMSC), to which the telephone number dialled by the user is assigned, whereby the contents of the message are analyzed and as a rule an automated reply is transmitted to the user. Such conventional short message service services only permit the processing of simple information requests, because with the despatching of the reply to the user the transaction is completed. In addition, the tendering of different kinds of offers through one telephone number for each one is not user-friendly and has the prerequisite of large resources at the short message service center. An ordering service is not possible with conventional short message service services of this kind. In connection with a short message service ordering service, a particular difficulty is the fact inherent in the short message service, that for acceptability reasons only very short information contents can be transmitted and that in addition the communication with the respective user cannot be maintained continuously, but rather that the information exchange is interrupted on the basis of the system specifications and can potentially contain messages uncoordinated with respect to time and contents.

### SUMMARY OF THE INVENTION

It is an object of the present invention to create a method, a system and a device, which makes possible an automated ordering system by means of a short message service.

It is a further object of this invention to create an ordering system, that, if so required, can process in real time a large number of offers to a great number of people, respectively and can process their orders in accordance with predefined criteria or existing customer data.

This invention foresees a virtual short message service center (vSMS C), with a user session management (USM) and therefore provides the possibility of also processing complex transactions between the user and the virtual short message service center. In doing so, the idea of the invention departs from the situation of providing a certain user with a particular status on the basis of a specific action, e.g., by an action message despatch by means of Push Offer. Incontrast to other systems, where in the case of the short message service reaching the usual short message service center only the contents (possibly also keywords) are evaluated, the invention enables the identification of the user and to interrogate his personal status with respect to the required transaction and to maintain a status management. As a result of this, it becomes possible to assign very short messages of a user, such as, yes, no, red, XL, etc., to specific aspects or questions, without the user being compelled to enter long explanatory texts, which with the currently prevailing user interfaces of the mobile telephones is possible only to a limited extent or else undesirable for operational reasons.

For better comprehension it shall be pointed out, that other short message service centers, such as those utilized by various operators, also record customer data. However, this data pertains to connection time, cost establishment and other information for the HLR (home location register) and are is designed for the real time evaluation in transactions with the user. The virtual short message service center in accordance with the invention furthermore, in the case of a global system for mobile communications network, does not require an SS7—link and therefore differs with other short message service center calls for a reduced implementation effort.

### BRIEF DESCRIPTION OF THE DRAWINGS

A more complete appreciation of the invention, and many of the attendant advantages, thereof, will be readily apparent as the same becomes better understood by reference to the following detailed description when considered in conjunction with the accompanying drawings in which like reference symbols indicate the same or similar components, wherein:

FIG. 1 illustrates an overview of a system in accordance with the invention;

FIG. 2 is a schematic illustration of the administration logic of the short message service center;

FIGS. 3a-3b together illustrate an exemplary sequence of an order transaction through an virtual short message service center;

FIG. 4 is a schematic illustration of the databases, which can be managed by means of the invention; and

FIG. 5 shows exemplary embodiments of the mobile instant shopping module/user session management implementation.

### DETAILED DESCRIPTION OF THE INVENTION

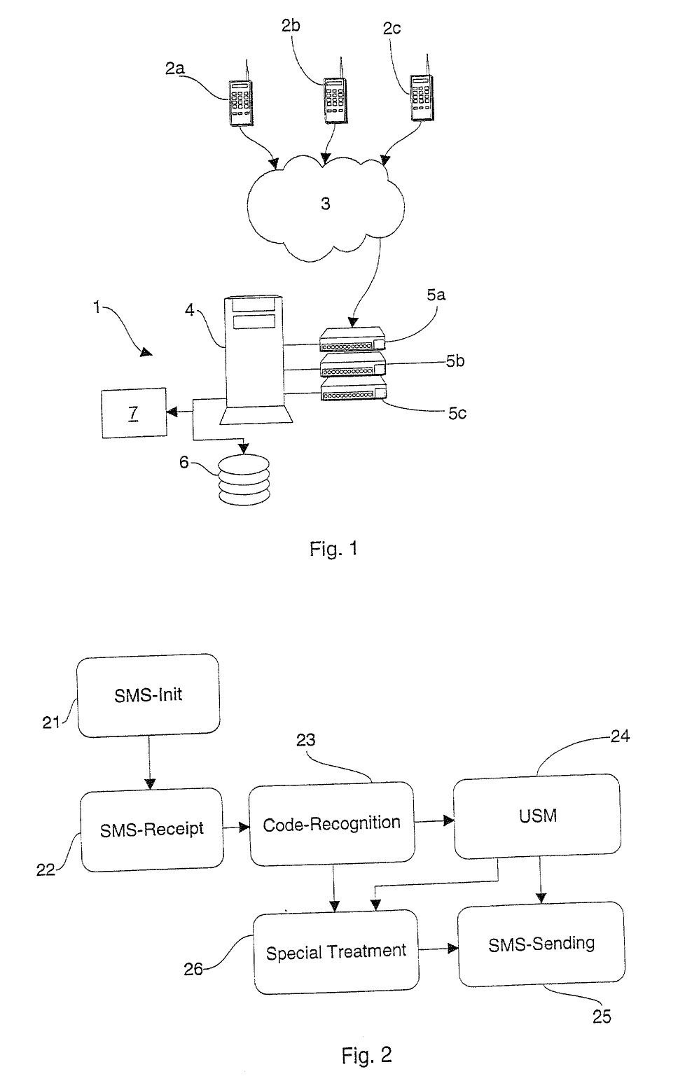

FIG. 1 shows a schematic overview of an arrangement for the system in accordance with the invention. One or several mobile telephones 2a-2c or corresponding short message service—compatible devices, for example, terminals, such as, e.g., personal digital assistant (PDA), are connected with a virtual short message service center 1 via a wireless infrastructure 3, typically a global system for mobile communication radio communication system or an analogue network. It is conceivable, that the wireless infrastructure 3 in certain areas also includes network parts with cable connections. The virtual short message service center 1 contains one or several short message service—compatible transmitting—/receiving modules 5a-5c, which for their part are connected with a computer 4. If so required, several computers or a corresponding cluster arrangement can be utilized. The functionality of the virtual short message service center 1 in a preferred embodiment is implemented by means of a Java application and carries out an independent of the protocol dispatching and routing system, in preference based on a transmission control protocol/internet protocol server. The system in particular can carry out an automatic conversion of the different protocols, store as well as pass on data and provides the necessary interfaces to additional applications, such as modules and the databanks possibly stored on third-party computers.

The computer 4 is connected with a user databank 6. This user databank can be stored directly in the computer 4 or in a preferred embodiment of the invention be connected with the computer 4 via a network infrastructure (local area network/wide area network, Internet etc.). The computer 4 manages the user data of the databank 6 by means of a monitoring function 7, which can be implemented by means of software or hardware. In doing so, the current user status is continuously stored. One or several traditional short message service center with SS7 -links, through which an short message is passed on to the virtual short message service center, are typically a component of the infrastructure 3 of a global system for mobile communications network. Within the scope of the invention, however, it is of course also possible to integrate the functionality of the virtual short message service center into a traditional short message service center wholly or partially, respectively, to connect it with the latter.

The communications logic on the virtual short message service center side is explained in more detail on the basis of FIG. 2. The virtual short message service center in accordance with the invention in an initial phase enables the despatch of one or several short message. The corresponding despatch is implemented in accordance with predefined criteria and using the user databank 6 (FIG. 1). An short message service receiving part 22 enables the receiving of any short messages transmitted by the user. A so-called recognition part 23 enables the evaluation of the short messages. Understood by this in the further sense is the analysis of the short message with respect to its logical assignment to a certain offer and to a certain user. The assignment to a certain offer can in preference be implemented by a keyword contained in the short message in a defined position, as a rule at the beginning of the message and the assignment to a certain user by the evaluation of the telephone number of the sender of the short message. Preferred possibilities of this code recognition are described in more detail further below.

The code recognition 23 in accordance with the invention now initiates a user session management (USM) dependent on the offer. Within the framework of the user session management, the user concerned is placed in a logical status, which is stored and managed by the databank by means of a user logfile or in another manner. The status management in preference is coupled with a time monitoring, so that other information units of the user received by short message service can be evaluated even with a minimum content and in addition plausibility checks become possible. The user session management will be explained in detail further below. A so-called special treatment part 26 already on the level of the code recognition 23 or in case of an undefined or particular user session management status enables the initialization of special handling by the virtual short message service center. For example, on receipt of short messages from users with telephone numbers from a specific -country or in case of deliberate disrupting actions a special handling routine can be initialized or in case, e.g., of the receipt of implausible short messages of a user, special measures can be undertaken during the USM, e.g., administrator messages initiated. The special treatment part 26 among others also enables the initialization of actions of a different kind than short messages, e.g., e-mails, fax messages, credit card verifications, etc. Both the user session management 24 as well as the special treatment part 26 enable the initialization (transmission) of short messages through the virtual short message service center or short message service center to the user concerned.

By means of the code recognition 23, essential information for the method in accordance with the invention is obtained. On the one hand, the user has to be unequivocally identified, on the other hand, a certain short message has to be assigned to a certain offer, respectively, service. The invention foresees several preferred possibilities of the code recognition logic, which can be combined with one another in different ways. The user identification can take place through the sender telephone number, a personal identification number code, evaluation of the short message service header or through a certain user name. Combinations of these identification parameters are possible. The identification of the service, such as the offer can be effected on the basis of the target telephone number, a keyword contained in the short message or by the evaluation of the short message service header. Requirements of the user-friendliness as a rule will limit the possibility of using the target telephone number as identification criterion. In the case of the current global system for mobile communication-short message service specifications, for the evaluation of an short message service header the TP-User-Data-Header-Indicator(TP-UDHI, Bit 6) has to be set to True and the required identification—or status information can be evaluated by means of a correspondingly defined header of the required length.

The procedure of an automated order processing can be split-up into—and described in three phases. In the first phase, the specification of the article or articles, respectively, of the offer as well as the data of the users, to which the article is to be offered, are recorded by the virtual short message service center. The preparation of this data optionally can be effected directly by the virtual short message service center or by the company, which wants to offer an article to users (service customer of the virtual short message service center). The users to be addressed with the offer are in preference combined into a group, so that in the further course other offers can be transmitted directly to the same user group. The corresponding data comprises information such as the name of the supplier, the name of the portal (list with a registered user group), article identification, article designation,—price and—description, country codes of the target countries, currency, stock inventory. Added as attribute data can be the type of the (expected) user reply, such as yes/no , number, word, etc., respectively, other attributes, such as size, categories, color, etc. Prepared as user data are the customer number, mobile telephone number, address, country, language, method of payment, personal identification number, user group, etc.

In the second phase, the virtual short message service center directly or through corresponding network links at the instigation of the supplier initializes the offer phase (refer to short message service-Init 21 in accordance with FIG. 2). In preference, the following data are used during this initialization phase: Name of the supplier, article identification, main text of the short message (utilization of article description, etc.) and the maximum time limit for the offer. By the specification of the user group or of a customer numbers list, this second phase can be initialized.

In the third phase, the code recognition as well as the user session management take place. In case the virtual short message service center offers the service as a service provider for third parties, depending on the service, respectively, the offer, the mobile telephone number and name (including address) are transmitted to the supplier as well as the number of articles ordered. The supplier's internal customer number is preferably also indicated, providing it has been made ready in the first phase.

In this manner, for example a short message with the contents Music shop X presents the new CD of singer Y: Songs for CHF 28.50. Reply with “OK”, for the order to be initiated can be transmitted to a user group. Expected now are incoming orders with the text content “OK”. An short message service registration could, for example, be foreseen as follows. Via the virtual short message service center, the message To order compact disks, you have to register once. Please send back address in the format (?First name?Name?Street?Postal code) or visit www.portal.com. is transmitted. Corresponding valid replies, for example have the Short message service content ?Thomas?Sample?Field Street 45?8008″. The two examples manifest, that it is part of the nature of II the invention to make possible an ordering system for text-based short messages. The short message service contents to be processed contain only short text components (including numbers and a limited set of additional symbols), which by means of the invention, despite this limitation, can be processed within the framework of secure and logical ordering processes. The enquiries form users can be processed in real time, whereby understood by this is not an immediate transaction processing, but one with a very short response time.

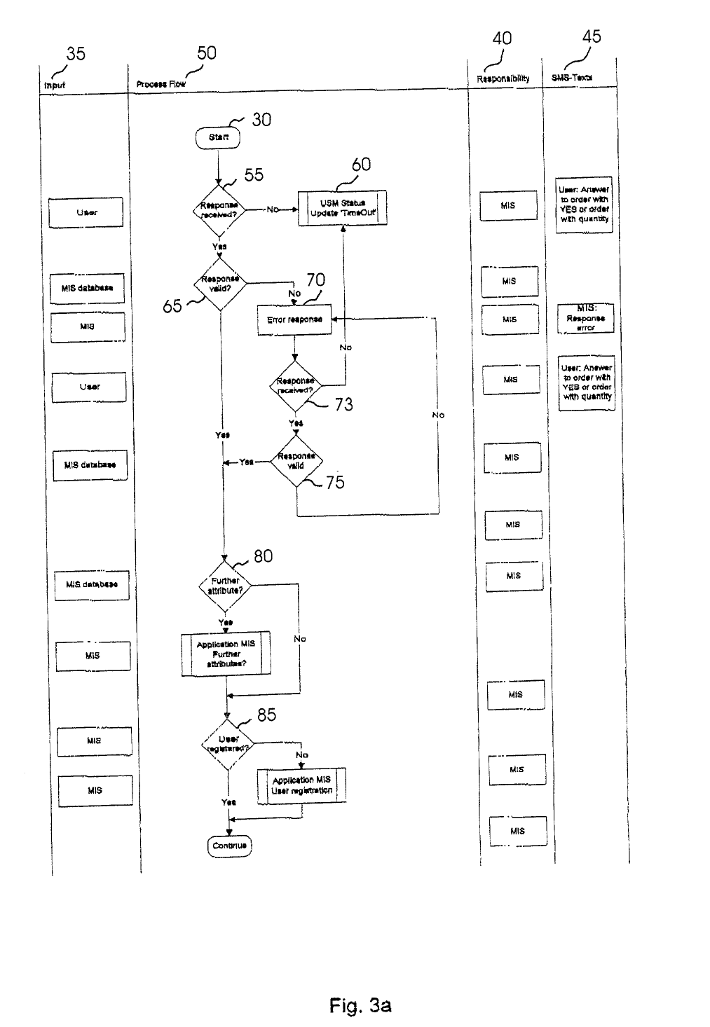

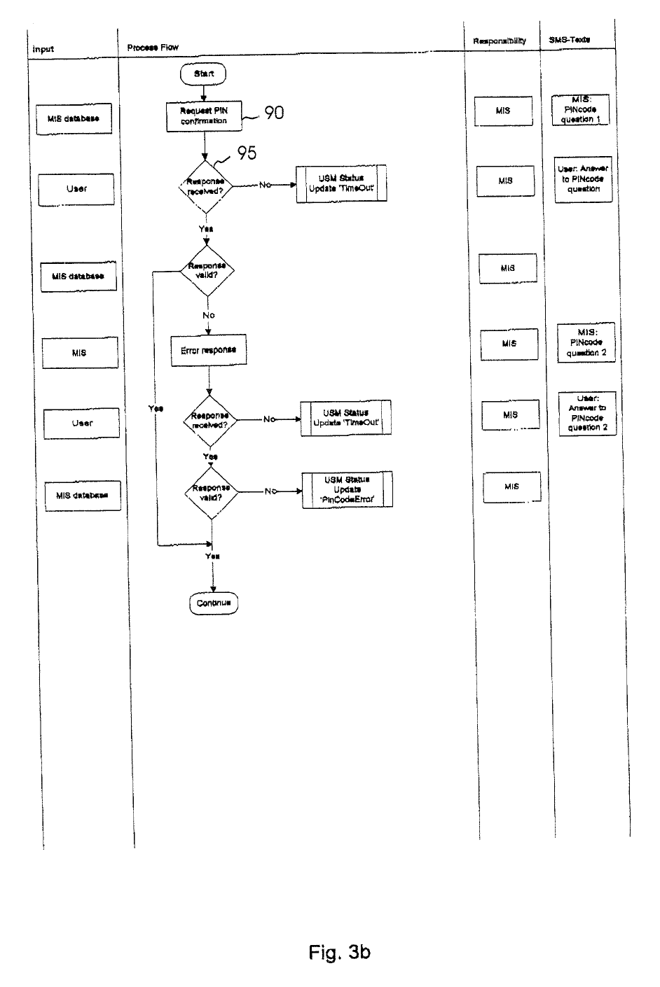

On the basis of the FIGS. 3a and 3b in the following a more complex example of an automated ordering procedure in accordance with the invention shall be explained. The logic explained above, respectively, the corresponding software/hardware modules are hereinafter designated as MIS (Mobile Instant Shopping Module). A certain offer, corresponding to the examples mentioned above, has been despatched to a user group by means of the mobile instant shopping module at a time before the start sign 30. In the FIGS. 3a and 3b in the first column respectively the Person responsible for the input 35, in the third column the Person responsible 40 for the evaluation of the message and in the fourth column a possible short message service text 45 with remarks are contained. The second column illustrates the procedural functional process 50 of the ordering system as well as the correspondingly implemented user session management status updates with respect to a user. For the sake of a clearer overview, the procedure is illustrated for one user only, whereby through the virtual short message service center simultaneously a multitude of parallel processes can be evaluated and transacted in parallel.

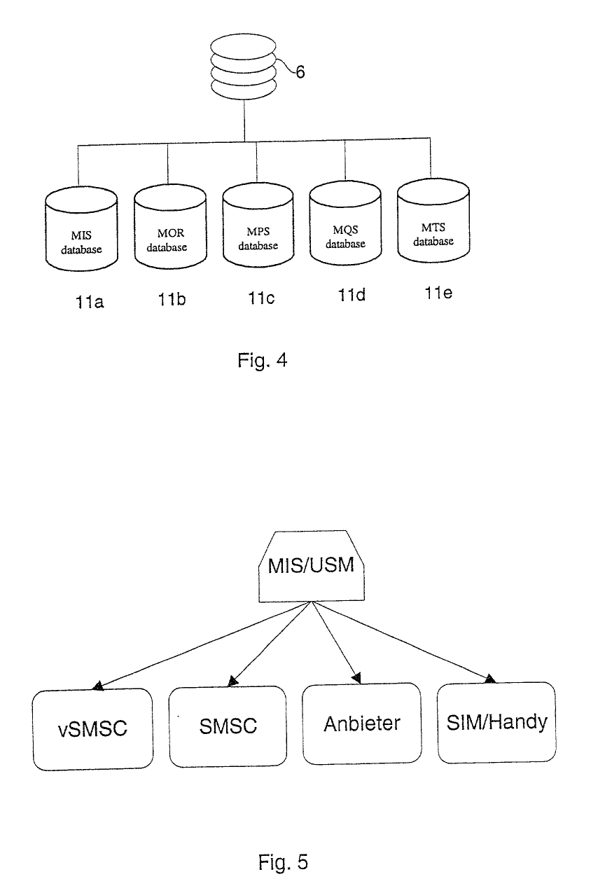

After the initialization of the Short message service—Receipt phase 22 (FIG. 2), the mobile instant shopping module in dependence of a certain, predefined time limit (TimeOut) determines, whether the user has sent back a reply 55. If the user does not send back a reply, then after the expiration of the time limit his user session management status is updated 60. If a reply is received, a validation check 65 in accordance with the validation rules predefined for the corresponding offer (e.g., check of the type of response) is carried out. If validation rules are not fulfilled by the short message service message of the user, then an error message 70 is returned to the user, for example, with the content Response error, please send a valid Short message service to . . . . If no valid reply is received within the time limit, the user session management status TimeOut is reset. If a further message is received 73, a new validation takes place 75. If the reply is again not valid, then if so required (not illustrated in this example of an embodiment) after the second wrong reply an abort can be initiated for the user concerned and the user session management status set to Abort, in order to prevent an endless loop until the definitive timeout. If the Short message service message of the user corresponds to the validation rules, then additional questions, e.g., with respect to product attributes 80 are input. Validation checks, abort and timeout in an analogue manner can be foreseen here too. After interrogation and response to all attributes/additional questions it is checked, whether a correct customer registration for the user concerned is present 85 and if so required a new registration is carried out (refer to the above example). In the first column input it is evident, that the mobile instant shopping module in case of certain conditions has to access corresponding mobile instant shopping module databanks (refer to FIG. 4).

In a next short message (FIG. 3b), the method of payment is interrogated, e.g., for the security check by means of a personal identification number (PIN) 90. If a short message with a correct personal identification number is received 95, then the mobile instant shopping module transmits a transaction confirmation to the user. Via the special treatment module (refer to FIG. 2), in addition to an short message service confirmation, e.g., an e-mail—or fax confirmation in accordance with the customer data can be foreseen. In preference a reconfirmation of the transaction confirmation from the mobile instant shopping module by the user is awaited and the latter given the possibility of cancelling the order (user session management status Cancel). During all communication transactions, the status of the corresponding user is continuously updated by the user session management. The user session management status information can for its part also be checked for plausibility, which can be carried out by the special treatment part (refer to FIG. 2). If, e.g., during a certain time interval several order return messages from the same user are received, then these either can be filtered (measure in accordance with the user session management status), a special short message service message can be initialized or a special remark be entered in the user logfile, which can be evaluated during the execution of the order by the supplier.

The user session management status monitoring, depending on the service or the offer, can contain different status information. In preference, at least a timeout status (the user has not responded within a predefined time limit, his session is terminated or secured by means of particular protective measures), an abort status (the user has transmitted a certain, predefined number of invalid replies; his session (possibly after a return query) is terminated, a cancel status (the user has cancelled his order; the session (possibly after a return query) is terminated), a personal identification number code error status (the user has made a certain, predefined number of wrong personal identification number code inputs; the session is terminated, possibly the order passed on to the supplier for manual processing) and an order OK status (the order was completed in a regular manner) are foreseen.

The user session management in accordance with the invention makes it possible to evaluate the messages received from the user, potentially uncoordinated with respect to time and content, specific to the service and also in the case of short contents to correctly analyze them, so that in accordance with the objective an automated ordering system, also in the case of a large number of transactions and users, can be implemented.

The code recognition in accordance with the invention, in a preferred embodiment makes it possible to make do with very few transmission—/receiving modules 5a-5c (FIG. 1). These transmission—/receiving modules can be implemented as response tracks, e.g., as global system for mobile communications modules with computer interface or as interfaces to virtual numbers on an short message service center, etc. Through the evaluation of a keyword, a multitude of offers can be received by few target telephone numbers and thanks to user session management nonetheless a clear customer management effected. The timeout status described above makes it possible after, e.g., 48 hours to keep a certain number free for a completely new service, so that the load on the computer 4 (FIG. 1) also in the case of extensive circular transmissions does not make too high demands of it. A further possibility of efficient code recognition provides the possibility of evaluating the short message headers, whereby the latter possibility is dependent on the specifications and the technical offering of the specific infrastructure supplier of the infrastructure 3 (FIG. 1).

For particular services, it is possible to enable the user to view his customer data, respectively, his order—and invoice data via an additional communication path, for example by means of a conventional web interface over the Internet. This possibility, however, is optional and not a compulsory component part of this invention, because on principle a more complicated technology, as an Internet access or WAP interfaces represent, shall not be required (but possible).

FIG. 4 schematically illustrates the tying-in of the user databank 6 with product data, ordering data or with other preferred extensions of the invention. The corresponding information, respectively, databanks can be located at the virtual short message service center or at its service users. Through corresponding software interfaces, conventional ERP applications can be included in the system in accordance with the invention. A first databank 11a designated as mobile instant shopping module Mobile Instant Shopping contains the information about the offers or products. A second databank 11b designated as MOR Mobile Order Request Module comprises the ordering system and the appertaining data. A third databank 11c designated as MPS Mobile Power Shopping contains additional modules for complex e-commerce solutions, e.g., with tying-in to the Internet. Further preferred solutions contain optional databanks for competition handling (databank 11d, MQS Mobile Quiz Solution) and databanks for the recording of statistics or other marketing information (databank 11e, MTS Mobile TED Solution).

FIG. 5 schematically illustrates the possible assignment of the mobile instant shopping module and/or the user session management. Already mentioned have been the possibilities of locating the logic and/or the data at the virtual short message service center, at the Short message service center or at the supplier (who as a rule obtains services from the operator of the virtual short message service center). A preferred alternative embodiment of the invention illustrated in FIG. 5 (subscriber identity module/Handy) foresees the implementation of a least parts of the mobile instant shopping module on a subscriber identification module (subscriber identity module card) for the mobile telephone, respectively, in its memory. subscriber identity module cards for mobile telephones are known, which in their as supplied condition contain software, which includes provider-specific logic. In addition it is possible at a later point in time by means of short message service to store further functions over the air (OTA) on the subscriber identity module card of the user. This in accordance with the invention is utilized by means of short messages for writing to or reading from the subscriber identity module cards of users. In this manner it is possible to at least partially implement the mobile instant shopping module described above on the subscriber identity module card. This makes possible, i.a., to locally intercept status changes of the user session management, i.e., at the mobile telephone user and as a result of this to avoid the unnecessary despatch of an short message. For example, the transmission of an short message with the wrong type of reply can be prevented. By means of dynamic menu expansion on the mobile telephone, effected by an OTA update of the subscriber identity module card, in addition special functions, such as, e.g., a Cancel function for the handling of the ordering system can be foreseen for the user. In preference, the status information stored on the subscriber identity module card is transmitted to the virtual short message service center when the next short message is transmitted. In accordance with the invention, therefore software (logic) and storage space for the management of user data concerning the ordering process are foreseen on the subscriber identity module card, whereby at least a part of the storage space can be read from and or written to by means of a virtual short message service center.

While the present invention has been particularly shown and described with reference to a particular embodiment thereof, it will be understood by those skilled in the art that various changes in form and details may be effected therein without departing from the spirit and scope of the invention as defined by the appended claims.

What is claimed is:

1. A method for a short message ordering service by means of mobile terminals, in particular mobile telephones, comprising the steps of:
despatching a text based short message with an enquiry to at least one mobile terminal by means of a virtual short message service center (virtual short message service center);
initializing a monitoring function (user session management) for the mobile terminal or terminals; and
exchanging of at least one further message between the mobile terminal or terminals and the virtual short message service center or setting of an abort status for the terminal or the terminals concerned by means of predefined criteria, wherein continually a user status check and user status updating is carried out for the terminal or the terminals at or through the virtual short message service center.

2. The method in accordance with claim 1, characterized in that the text based short message and the group of the mobile terminals is prepared by a computer system connected with the virtual short message service center.

3. The method in accordance with claim 2, characterized in that the status check and the status updating is effected by the evaluation of the mobile telephone number and a keyword contained in the short message.

4. The method in accordance with claim 3, characterized in that the status check and status updating is effected by the evaluation of the mobile telephone number and of the short message header.

5. The method in accordance with claim 4, characterized in that at least parts of the monitoring function and/or of the status check are stored on the mobile terminal.

6. The method in accordance with claim 5, characterized in that at least parts of the monitoring function and/or of the status check are stored at an short message service center.

7. The method in accordance with claim 6, characterized in that through the virtual short message service center short messages are transmitted to a mobile terminal, which dynamically change the menu of the mobile terminal with ordering procedure menu points.

8. A system for a short message ordering service, comprising:
means of mobile terminals, in particular mobile telephones, with a wireless infrastructure (3) with a multitude of mobile user terminals (2a-2c), characterized by a virtual short message service center (1), which is connected with the infrastructure (3), and which has at least one transmission/receiving module (5a-5c), which is connected with a computer (4) and with a user databank (6), which manage continuous status updating of the user terminals concerning the ordering process.

9. A device for a short message ordering service by means of mobile terminals (2-2c), in particular mobile telephones, characterized by at least one transmission—/receiving module (5a-5c) connected with a computer (4) and a user databank (6) for the reception of short messages, whereby the computer (4) continuously manages user data of the user databank (6) concerning the ordering system and stores information about the respective current user terminal status.

10. A method in accordance with claim 5, characterized in that a subscriber identification module (subscriber identification module card) contains software and storage space for the management of user data concerning an ordering process, whereby at least parts of the storage space are readable from—and/or writable to by means of a virtual short message service center.

11. An apparatus for short message ordering service, comprising:
a plurality of cellular telephones carried by individuals whom orders are made to;
a plurality of short message service transmitting and receiving terminals for processing orders;
a wireless infrastructure connecting said plurality of cellular telephones to said plurality of transmitting and receiving terminals; and
a user databank connected to a computer connected to said transmitting and receiving terminals, said user databank storing current user status of said individuals on said plurality of cellular telephones.

12. The apparatus of claim 11, wherein said wireless infrastructure is a Global System for Mobile communication.

13. The apparatus of claim 11, wherein said databank is connected to said computer via Internet.

14. The apparatus of claim 11, wherein said databank is connected to said computer by a Local Area Network.

15. The apparatus of claim 11, wherein said individuals using said plurality of cellular telephones can be asked questions and said individuals can answer questions posed to them by said computer.

16. A method of short message ordering, comprising the steps of:
establishing a communication channel between a short message service center and an individual carrying a cellular telephone;
interrogating said individual to determine a profile of said individual;
offering to sell an item or a service to said individual;
interrogating said individual to determine the exact specification of a product that said individual prefers; and
completing said sale by exchanging payment information with said individual.

17. The method of claim 16, wherein a plurality of individuals, each carrying a cellular telephone, are interrogated and offered to buy an item or a service.

18. The method of claim 16, wherein the step of interrogating said individual to determine the exact specification of a product comprises asking said individual questions consisting of the group of what size, what color, what quantity, and what model number.

19. The method of claim 16, wherein the step of completing the sale can be accomplished by facsimile, e-mail, or credit card verification.

20. The method of claim 16, further comprising the step of identifying the user by way of personal identification number, telephone number, or short message service header.
